(19) United States
(12) Patent Application Publication
(10) Pub. No.: US 2018/0147422 A1
(43) Pub. Date: May 31, 2018

(54) ESCAPE SYSTEM USING A TEXTILE ELEMENT OF VARIABLE DIAMETER

(71) Applicant: ZEDEL, Crolles (FR)

(72) Inventor: Alain MAURICE, Saint Hilaire du Touvet (FR)

(73) Assignee: ZEDEL, Crolles (FR)

(21) Appl. No.: 15/827,773

(22) Filed: Nov. 30, 2017

(30) Foreign Application Priority Data
Nov. 30, 2016 (FR) 1661739

(51) Int. Cl. A62B 1/14

(52) U.S. Cl. CPC A62B 1/14

(57) ABSTRACT

An escape system including a textile support of variable cross-section including a first part having a first cross-section and provided with a first end and a second part having a second cross-section smaller than the first section and provided with a second end, a descender mounted sliding along the textile support from the first part to the second part, and configured to exert a braking force on the textile support. At least one brake mounted sliding along the textile support is placed between the descender and the second end, at a distance from the descender so as to allow movement of the descender independently of the brake. The brake able to move at least in the second part, configured to exert additional braking force on the textile support when moving the brake to the second end, configured to prevent the descender from moving alone in the second part.

### BACKGROUND OF THE INVENTION

The invention relates to an escape system using a textile element of variable cross-section such as a rope or a strap.

### STATE OF THE ART

In the field of various work activities, a person may be required to leave a location in an emergency for safety reasons. For example, in the event of a structure being weakened or because of a fire at a height, the only solution to evacuate the location can be to make an emergency abseiling. To do this, professionals must always have their abseiling equipment at hand.

EP 3056248 patent application describes abseil equipment for emergency situations. The abseil equipment includes a self-locking descender associated with a rope, the descender allowing abseiling to be performed down the rope.

The main disadvantage of this type of equipment is its weight, as the rope length for abseiling can be important. For example, for wind energy professionals, it is necessary to have a 100 m rope to be able to abseil from the top of the wind turbine. The equipment can weight several kilos.

The abseiling equipment is in addition to other safety devices and tools that are essential for the user's professional activity. Therefore, the lighter the equipment, the more appreciated it is by users.

### OBJECT OF THE INVENTION

An object of the invention is to provide a light and reliable escape system allowing emergency abseiling.

For this purpose, the escape system comprises:
a textile support of variable cross-section comprising a first part having a first cross-section and provided with a first end and a second part having a second cross-section smaller than the first section and provided with a second end,
a descender mounted sliding along the textile support from the first part to the second part, and configured to exert a braking force on the textile support,
at least one brake
   mounted sliding along the textile support, disposed between the descender and the second end, at a distance from the descender so as to allow the descender to move independently from the brake,
   capable of translating at least in the second part,
   configured to exert an additional braking force on the textile support when the brake is moving toward the second end,
   configured to prevent the descender from moving alone in the second part.

Preferably, the textile support can be a rope.

According to one aspect of the invention, the brake can be initially mounted on the second part, close to the junction between the first part and the second part. Thus, during an escape, when the descender leaves the first part, the brake immediately acts to descend to the second part. It can also be configured to be unable to translate in the first part. The brake may be a pad with at least two holes having complementary shapes of the shape of the textile support in the second part.

As far as the descender is concerned, the descender can be a variable intensity braking device, configured to be stationary on the textile support in the absence of the exercise of an external force.

The escape system may also include a securing device attached to the first end of the textile support. This makes it easier to anchor the escape system in the event of an emergency escape.

The escape system may also include means for storing at least the first part of the textile support.

The escape system can be configured so that the descender can be brought into contact with the brake during abseil, or the descender can always be placed at a distance from the brake.

In a first embodiment, the descender can have a stop configured to retain the brake outside the descender. The stop can be a U-shaped piece through which the textile support passes.

When the brake is held at a distance from the descender, the brake can then be attached to the means for storing.

According to an advantageous embodiment, the sum of the braking force and the additional braking force in the second part of the textile support can be greater than or equal to the braking force in the first part of the textile support. This allows the user to control the abseil during a first period to leave the steep and dangerous area, and then to descend evenly when the abseil is vertical.

Another object of the invention is to provide an escape method with a lighter and reliable escape system.

The method for escaping is remarkable in that the method comprises:
providing an escape system according to one of the previous embodiments, the descender being attached to a user, the first end of the textile support being fixed to a anchor point ;
moving the descender along the textile support in the first part until reaching the second part of the textile support, the descender moving independently from the brake, the brake being disposed between entre descender and the second end of the textile support,
connecting the descender to the brake so as to add an additional braking force when the descender moves along the second part toward the second end.

### BRIEF DESCRIPTION OF THE DRAWINGS

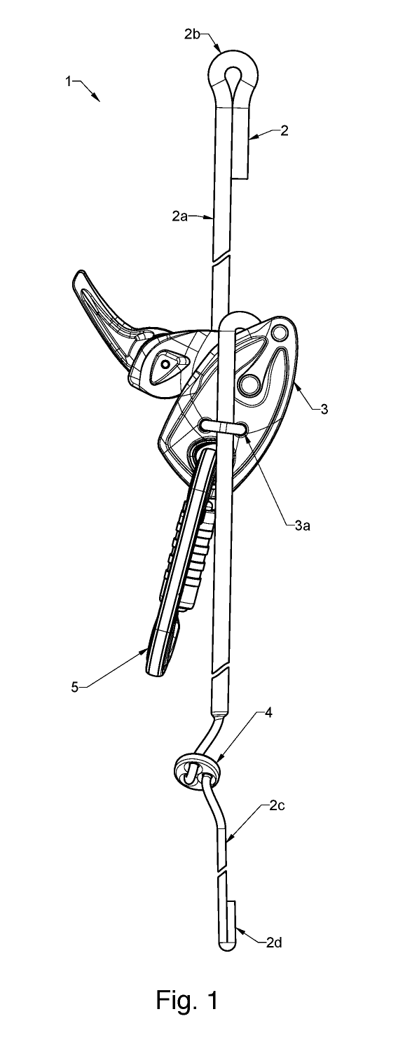

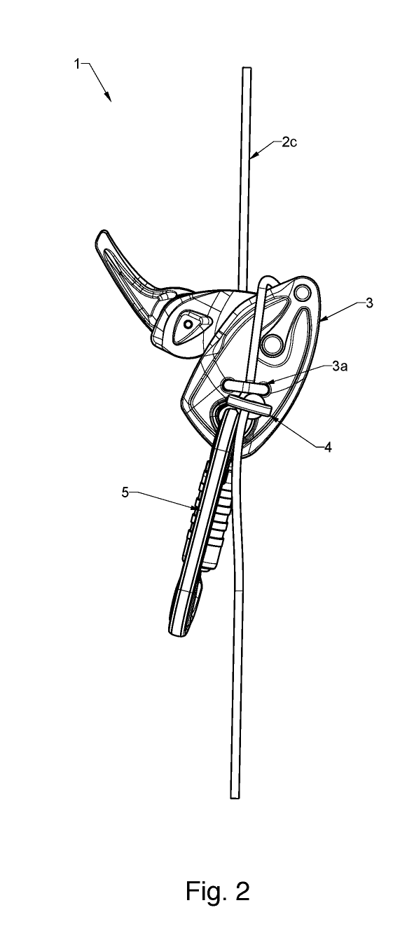

Other advantages and features will become more clearly apparent from the following description of particular embodiments of the invention given for non-restrictive example purposes only and represented in the appended drawings in which FIGS. 1 and 2 schematically illustrate an escape device according to a first embodiment.

### DETAILED DESCRIPTION

An object of the invention relates to an escape system 1 comprising a textile support 2, a descender 3, and at least one brake 4.

The textile support 2 advantageously comprises a first part 2a with a first cross-section and provided with a first end 2b. The textile support 2 also comprises a second part 2c with a second cross-section smaller than the first cross-section and provided with a second end 2d. In advantageous manner, the difference of the cross-sections is at least equal to 15%, preferably at least equal to 30% advantageously, at least equal to 50%. For example, the cross-section of the second part 2c is double the cross-section of the first part 2a.

The textile support 2 can advantageously have a circular cross-section, the cross-section of the first part 2a having a larger diameter than the cross-section of the second part 2b.

The first part 2a of the textile support 2 can have a length between 2 m and 20 m, while the second part 2c of the textile support 2 can be up to 100 m long, for example when escape system 1 is used in wind energy.

For example, the textile support can be a rope or a strap. For example, the first part 2a can be formed by folding the textile support 2 on itself, so as to increase its cross-section. Alternatively, the first part 2a may be an area of the textile support 2 covered with a sheath so as to increase the cross-section value. It is also possible to adapt the weaving of the textile support in order to directly modulate its cross-section.

In order to keep the escape system 1 as small as possible so as not to burden so much the user, storage means (not shown) for example a storage bag configured to store of at least the second part 2c of the textile support 2 may be used. Ideally, storage means can contain the entire escape system 1. They can be configured to be attached to the user's harness (not shown) or to the user so that the escape system 1 is always within reach in case of emergency.

When the escape system 1 is used, the textile support 2 can be securely attached to an element strong enough to support a user's weight during an abseil. A knot can be made at the first end 2b of the textile support 2.

Alternatively, the escape system 1 can be equipped with a securing device (not shown) which is advantageously attached to the first end 2b of the textile support 2. In this case, the first end 2b can for example have a ring shape in order to be able to hook the securing device. Thanks to a securing device, the escape system 1 can be quickly attached and allows for quicker evacuation in case of an emergency.

Regardless of whether or not the escape system 1 is equipped with a securing device, the first end of the textile support can be considered as the anchor point of the escape system 1. Thereafter, the anchor point comprising the first end 2b of the textile support 2b may be regarded as the top of the escape system, while the second end 2d of the textile support 2d may be regarded as the bottom of the escape system.

The descender 3 is mounted sliding on the textile support 2, and is configured to slide in the direction of the second end 2d. The descender 3 is configured to exert a braking force on the textile support 2 so as to restrict the speed of the person performing abseiling.

The descender can have variable braking intensity. What is meant by a descender 3 with variable braking intensity is a descender where the user blocks more or less the textile support 2 directly with his hands in order to modulate braking intensity of the descender 3. In an advantageous way, the descender with variable braking intensity has a control handle which is configured to define the friction force and thus the braking intensity. Such embodiment is particularly advantageous in the first part of the textile support because the user usually has to move in areas with variable slopes, which means that the braking intensity must be controlled.

The descender 3 can be a self-locking device. What is meant by self-locking is a descender allowing braking intensity to vary, braking intensity being controlled by the user by means of a control handle which is an integral part of the descender 3. The descender 3 is also able to completely slow down so as to stop the user's abseil if the user does not use the control handle. The descender 3 is then stationary on the textile support 2. This embodiment of the descender 3 is illustrated in FIGS. 1 and 2.

Regardless of the type of descender 3 used in the escape system 1, the descender is attached to the harness (not shown) of the user performing abseiling by means of fastening means. Fastening means or fasteners can be, for example, a carabiner 5 (see FIGS. 1 and 2) or a quick link.

According to a particular embodiment illustrated in the figures, the escape system 1 may have a single brake 4. As the descender 3, the brake 4 is also mounted sliding along the textile support 2, and is advantageously positioned between the descender 3 and the second end 2d. The brake is configured to be able to move at least in the second part of textile support 2c.

The role of the brake 4 is to exert an additional braking force on the textile support 2 during abseil of the user, i.e. when the brake 4 moves toward the second 2d end of the textile support 2.

In order to facilitate the start of abseiling, the brake 4 is initially placed at a distance from the descender 3 so as to allow the descender 3 to move independently from the brake 4. In this configuration, only the descender 3 exerts a braking force on the textile support 2. This is particularly advantageous because at the start of the abseiling, the user often has to walk between the anchor point of escape device 1 and the actual start of the abseil. Therefore, braking does not need to be important because the user is not yet suspended in the air by means of the escape system 1.

The first part 2a of the textile support 2 has a high linear weight but also high abrasion resistance. This is particularly advantageous near the anchor point when the textile support 2 changes direction to start the vertical part of the abseiling.

The second part 2c of the textile support 2 has a low linear weight, which is advantageous for reducing the total weight of the escape device and its total volume. On the other hand, abrasion resistance is lower. It is therefore advantageous to use this small cross-section in the vertical part of the textile support 2 because the friction is very low.

The braking force exerted by the descender 3 on the textile support 2 varies according to the size of the textile support 2. The larger the cross-section of the textile support is, the higher can be the braking force. Therefore, when the descender 3 reaches the second part of the textile support 2c, the braking force exerted by the descender 3 decreases. If the cross section difference is very large, e.g. a ratio of 2, the descender may not be able to effectively control the abseil and the maximum braking position does not allow stopping the user.

Also, in order to guarantee the user's safety, the brake 4 is advantageously positioned to prevent the descender 3 from moving alone in the second part 2c of the textile support 2. In this way, from the moment that the descender 3 arrives in the second part 2c, the user is not only braked by the braking force exerted by the descender 3, but also by an additional braking force exerted by the brake 4.

The additional braking force exerted by the brake 4 on the textile support compensates for the reduction in braking intensity applied by the descender 3. The combination of a narrow textile support 2, a descender 3 and a brake 4 makes it possible to achieve an equally intense and effective braking as the combination of a wide textile support 2 and a descender 3. The fact that the second part 2c of the textile support is less wide than the first part 2a, and that a brake 4 is used, makes it possible to make the escape system 1 much lighter than the devices of the prior art, being just as reliable.

The brake 4 may, for example, be configured so that the sum of the braking force and the additional braking force when the descender 3 and the brake 4 slide in the second part 2c, is greater than or equal to the maximum braking force exerted by the descender 3 when the descender is in the first part 2a. In this way, the user can quickly escape from the area to be evacuated, and continue to abseil more slowly when in a safer area.

To optimize the operation of the brake 4, it can be configured to be positioned at the junction between the first part 2a and the second part 2c of the textile support 2. In this way, it does not exert additional braking force in the area where the descender 3 exerts the greatest force, i.e. the first part 2a. In this configuration, the brake 4 assists braking by applying an additional braking force in the area where the braking force exerted by descender 3 is lower, i.e. the second part 2c.

To prevent the brake 4 from exerting additional braking force in the first part 2a of textile support 2, the brake 4 may be configured so that it is not possible to move into the first part 2a of the textile support 2. To achieve this, the structure of the brake 4 can for example be adapted so that it cannot be moved to the first part 2a.

For this purpose, the brake 4 may for example be a brake pad with at least two holes having shapes complementary of the shape of the textile support 2 in the second part 2c and also know as energy absorber. This particular embodiment of the brake 4 is illustrated in FIGS. 1 and 2. In such configuration, the brake 4 can slide along the second part 2c of textile support 2, and is locked at the junction between the first part 2a and the second part 2c. The brake 4 may be formed by other embodiments wherein the brake 4 comprises at least two holes separated by a friction area where the textile support 2 slides. For example an additional descender, a belay device, a friction descender may be used.

In the particular case where the textile support 2 is a rope of circular cross-section, brake 4 can be a pad provided with two holes that prevent the rope from passing through in the first part (large diameter section) and allow the rope to pass through in the second part (small diameter section).

However, the use of a brake 4 different from a brake pad may be considered. In fact, the brake 4 can have the shape of a tube where the textile support comes to rub against two opposite walls of the tube to exert friction. The shape of the tube can be any shape. The same may be true for the shape of the holes in the brake pad provided that the brake pad exerts a friction force when moving in the second part 2c. The brake 4 can also be in the form of a descender with two flanges that define a circulation path of the textile support 2. The advantage of the brake pad lies in its ease of manufacture and compactness while ensuring a controlled friction force by adapting the number of holes, the size of the holes and the shape of the holes.

The arrangement of the brake 4 relative to the descender 3 can be considered in different ways. In an embodiment, the brake 4 can be mounted slidingly on textile support 2, and be free to move with respect to the harness (not shown). Alternatively, the brake 4 can be mounted sliding on the textile support and fixed directly or indirectly to the harness.

When the brake 4 is free to move with respect to the harness, the descender 3 and the brake 4 may come into contact during the abseil. This is especially true when the brake 4 is too small to be held by hand, for example when the brake 4 is a brake pad as shown in FIGS. 1 and 2.

To avoid entanglement of the descender 3 and the brake 4, the descender 3 can be equipped with a stop 3a which blocks the brake 4 outside the descender 3. This ensures optimum operation of the escape system 1 during abseil.

For example, the stop 3a can be a U-shaped part with the ends fixed to the descender 3, so as to form a ring through which the textile support 2 can slide. This embodiment is illustrated in FIG. 2. This configuration allows the descender 3 and the brake 4 to operate in such a way as to exert the braking force and the additional braking force.

At the beginning of the abseil, and when the descender 3 is still in the first part 2a of the textile support 2a, the user can gain speed despite the braking force exerted by the descender 3. Also, when the descender 3 comes into contact with the brake 4, the additional braking force exerted by the brake 4 on the textile support 2 is added to the braking force exerted by the descender 3 on the textile support 2.

If the brake 4 is large enough to be hand-held, the brake 4 may be free to move with respect to the harness, without coming into contact with the descender 3. Here, a marker placed between the brake 4 and the first end 2b can signal to the user that he must slow down his abseil in order to pick up the brake 4 by hand before the latter comes into contact with the descender 3.

It is also possible to provide for an embodiment of the escape system in which the brake 4 is large enough to act as a saddle or platform on which the user can sit or stand. Such an embodiment may be considered when the user does not need to carry the escape system 1 with the rest of his equipment, e.g. when the escape system is placed preventively in a high-risk area so as to be used in case of emergency.

According to another embodiment, the brake 4 can be attached to the harness. For example, the brake can be fastened directly to the harness, or it can be fastened to the harness by means of the storage means of the textile support 2 if the escape system 1 is fitted with storage means. To attach the brake 4 to the harness, the brake 4 may have a hole through which a fastening element such as a strap, carabiner or quick link can pass.

The escape system 1 may also contain several brakes with similar properties to the brake 4 described above. By using multiple brakes, additional braking forces can be added. One can imagine, for example, that the number of brakes fitted to the escape system depends on the user's weight. For example, a heavier person will be able to use an escape system with multiple brakes, while a slimmer person will be able to use an escape system 1 with a single brake 4.

The invention also concerns a method of escape using an escape system 1 such as the one described above.

To leave an aerial work site in case of emergency, the first step is to attach the escape system 1 to an element strong enough to support the user's weight during an abseil.

The textile support 2 must then be tensioned so that the user can sit in the harness and start the abseil. This may not be immediate after attaching the escape system 1. If the user has to step over objects, e.g. in the event of a fire, he or she must first walk to reach an area where he or she can tension the rope and hang himself or herself using the escape system 1. The user is therefore directly or indirectly connected to the descender 3 in order to abseil.

The user can then slide along textile support 2 towards the second end 2d by controlling the braking force exerted by the descender 3 on the textile support. Advantageously, the descender 3 moves along the textile support 2, in the first part 2a, independently of the brake 4. The abseiling speed is regulated by the braking force provided by the descender 3.

As mentioned above, when the descender 3 reaches the second part 2c, the braking force decreases due to a reduction in the cross-section of the textile support 2. It is then advantageous to connect the brake mechanically with the descender in order to have a simultaneous movement of the brake 4 and the descender 3 and thus exert the braking force and the additional braking force. Depending on the embodiments described above, the mechanical connection between the brake 4 and the descender 3 can be achieved by direct physical contact or indirect contact, for example by means of the user or another attachment point.

If the brake 4 is mounted mobile with respect to the harness, and the brake can come into contact with the descender 3, e.g. if it is too small to be held correctly in the hand, then the user can advantageously slow down the abseil by coming close to the brake 4 in order to avoid a brutal shock which could be unpleasant for him and detrimental to the equipment. Braking can be triggered by the presence of a marker on the textile support, which signals the presence of the brake 4.

When the descender 3 and the brake 4 are in contact, the user can then continue abseiling to the second 2d end of the textile support 2.

If the escape system is configured so that the descender 3 and the brake 4 do not come into contact, the user can perform the entire abseil down to the second end of the textile support 2. This is possible, for example, when the user can take the descender 3 in one hand and the brake 4 in the other hand, or when the brake 4 is large enough so that the user can sit on it or keep it at a distance with his feet.

The escape system 1 as it has just been proposed is much lighter than the prior art devices thanks to the variable cross section of textile support 2, and is just as reliable thanks to the simultaneous use of the descender 3 and the brake 4 in the area where textile support 2 is the narrowest.

1. An escape system comprising:
a textile support of variable cross-section comprising a first part having a first cross-section and provided with a first end and a second part having a second cross-section smaller than the first section and provided with a second end,
a descender mounted sliding along the textile support from the first part to the second part, and configured to exert a braking force on the textile support,
at least one brake mounted sliding along the textile support in the second part toward the second end;
wherein the brake is distinct from the descender so that the descender is able to move independently from the brake at least in a portion of the first part, the brake being disposed between the descender and the second end, and
wherein the brake is configured to prevent the descender from moving alone at least in a portion of the second part so that the brake and the descender move simultaneously and the brake exerts an additional braking force on the textile support when the brake is moving toward the second end.

2. Escape system according to claim 1, wherein the textile support is a rope.

3. Escape system according to claim 1, wherein the brake is configured to be unable to move along the textile support in the first part.

4. Escape system according to claim 1, wherein the brake comprises at least a hole having a cross-section smaller than the first cross-section so as to prevent the brake form sliding along the first part.

5. Escape system according to claim 1, wherein the brake is initially mounted on the second part of the textile support, close to the junction between the first part and the second part.

6. Escape system according to claim 1, wherein the brake is a pad with at least two holes having shapes complementary of a shape of the textile support in the second part so as to prevent movement of the brake along the first part.

7. Escape system according to claim 1, comprising a securing device attached to the first end of the textile support.

8. Escape system according to claim 1, comprising a storing bag configured to store at least the first part of the textile support.

9. Escape system according to claim 7, wherein the brake is attached to the storing bag.

10. Escape system according to claim 1, wherein the descender has a stop configured to retain the brake outside the descender.

11. Escape system according to claim 9, wherein the stop is a U-shaped piece through which the textile support passes.

12. Escape system according to claim 1, wherein the descender is a variable intensity braking device, configured to be stationary on the textile support in the absence of the exercise of an external force.

13. Escape system according to claim 1, wherein a sum of a braking force provided by the descended and an additional braking force provided by the brake in the second part of the textile support is greater than or equal to the braking force of the descender in the first part of the textile support.

14. A method for escaping comprising:
providing an escape system including
a textile support of variable cross-section comprising a first part having a first cross-section and provided with a first end and a second part having a second cross-section smaller than the first section and provided with a second end, the first end of the textile support being fixed to a anchor point
a descender mounted sliding along the textile support from the first part to the second part, and configured to exert a braking force on the textile support, the descender being attached to a user,
at least one brake mounted sliding along the textile support in the second part toward the second end;
moving the descender along the textile support in the first part until reaching the second part of the textile support, the descender moving independently from the brake, the brake being disposed between entre descender and the second end of the textile support,
moving simultaneously the descender and the brake so as to add an additional braking force when the descender moves along the second part toward the second end.
